(19) United States
(12) Patent Application Publication
(10) Pub. No.: US 2016/0370253 A1
(43) Pub. Date: Dec. 22, 2016

(54) POWDER SEGREGATION TESTING APPARATUS AND METHOD OF USING

(71) Applicant: Sanyasi R. Kalidindi, Monroe, NJ (US)

(72) Inventor: Sanyasi R. Kalidindi, Monroe, NJ (US)

(21) Appl. No.: 14/744,649

(22) Filed: Jun. 19, 2015

(51) Int. Cl. G01M 7/02

(52) U.S. Cl. CPC G01M 7/022

(57) ABSTRACT

The invention provides an apparatus and method for testing powder properties. The apparatus has a sample holder with a planar membrane supported therein. The sample holder is mounted in a housing in a manner to allow relatively free vibrations. A quantity of powder or powder blend is placed on the membrane and the housing and sample holder are subjected to vibration, causing segregation. The powder is transferred to a split tablet die for compaction and the compacted tablets are tested for component uniformity.

### FIELD OF THE INVENTION

The present invention relates to the field of laboratory apparatus and methods, and more particularly to apparatus for testing of powders and powder blends for segregation of the components.

### BACKGROUND OF THE INVENTION

Many pharmaceutical, food, cosmetic, and chemical products are made by blending different powders or granules prior to compression into tablets, as well as the filling of capsules, bottles, pouches, etc. Although the original blend may have an acceptable level of content uniformity, such further processing—which may involve auger feeding, vibration feeding, screw feeding, vacuum transfer, etc.—may potentially lead to partial segregation of the ingredients, which in turn will affect dosage uniformity. If one of the ingredients in a powder drink mix, for example, is an artificial sweetener, drinks made from different pouches of such a mix in which components have been segregated due to handling, will taste differently. Similarly, if one of the ingredients in a pharmaceutical blend is an active ingredient, any degree of segregation may render the dosage form potentially ineffective or dangerous. Another example is a disintegrant, used in solid pharmaceutical dosage forms (tablets and capsules, for example) typically at a level of 2-4% to help the dosage form disintegrate when it comes in contact with stomach fluids. Since a disintegrant is an excipient (an inert material, not an active ingredient), formulators are not generally concerned about its segregation. However, a disintegrant is a critical component in a solid dosage formulation in that it is needed for proper disintegration and dissolution. If the disintegrant has become partially segregated, some tablets/capsules may fail the dissolution specification. Ideally, powder blends should be tested for potential segregation problems at the formulation development stage. Once the product is being manufactured on a production scale, segregation problems are very difficult to correct because of regulatory or economic constraints. However, at the formulation development stage, laboratory batch sizes are small and the processing times of such batches are too short for a segregation problem to be detected with presently known techniques as segregation tends to develop over a period of time.

An Apparatus And Method For Testing Powder Properties is disclosed in U.S. Pat. No. 5,583,304 to the present inventor. The apparatus disclosed is mounted within a three-compartment housing that has a hopper connected to a programmable vibrator to simulate production conditions. The hopper has a rotatable butterfly valve in the exit chute. A carousel with multiple sample-receiving stations is mounted below the hopper exit chute and caused to rotate cyclically. There are a few fundamental problems with this apparatus which render it practically useless, for example: (a) powder segregation does not occur when a static powder bed is subjected to vibration; (b) the flow of the powder from the hopper is impeded because the powder path width reduces drastically from the hopper stem to the funnel die stem; (c) the flow of the powder is also hampered by the butterfly valve in the stem of the hopper; and (d) reproducibility of vibration intensity is doubtful because the vibration device is mounted to the wall of the enclosure at a location remote from the hopper.

Another invention by the present inventor, disclosed in U.S. Pat. No. 7,204,164, is an improvement upon the apparatus of U.S. Pat. No. 5,583,304 by (a) altering the geometry of the hopper stem to improve powder flow; (b) incorporating a new gate system to control the powder flow; (c) providing an improved technique for taking multiple unit-dose samples of the powder at predetermined intervals during testing; (d) directly linking the vibration device to the hopper for maximum vibration transmission to the hopper and assuring that the vibration intensity is reproducible; and (e) providing a novel apparatus that can be used for studying segregation potential, testing particle size distribution and flow rates of powders, resulting in a versatile apparatus. This apparatus, though much better in design than the apparatus of U.S. Pat. No. 5,583,304, still suffers from the following drawbacks: (a) a large sample size (1-3 kg) is required for meaningful testing; (b) flow of the powder blend from the hopper stem is inconsistent; (c) different formulations of the same product may require different gate openings for acceptable flow, potentially biasing the results; and (d) the apparatus is cumbersome.

U.S. Patent Application No. 2015/0020597 A1, filed by the same inventor, describes another accelerated powder segregation apparatus and method utilizing an ascending spiral channel which is connected to a vibration device. A powder sample is placed at the bottom of the ascending channel and subjected to vibration which causes the powder to travel upwards on the spiral channel. When the powder exits after traversing the spiral channel, it fills a number of cavities in a split sampling die to be compacted into tablets and analyzed for content uniformity. Although this apparatus and method is effective with a small sample, such as 10 g, there are two disadvantages: (a) each type of powder or powder blend travels at a different speed on the spiral channel depending on its flow characteristics, bulk density, particle size and particle morphology, which means each type of powder or powder blend is subjected to vibration for different time periods; and (b) the testing time cannot be controlled because one can collect the powder only when it exits the spiral channel.

Thus, there is a need for a simple, practical and economical apparatus and method to perform accelerated segregation testing which requires only a small sample of powder or powder blend, which subjects any type of powder or powder blend to the same period of vibration allowing all formulations to be compared under the same conditions. The present invention provides such an apparatus and method.

### SUMMARY OF THE INVENTION

The invention provides an apparatus and method for testing the degree of segregation of powder or a powder blend in a laboratory environment to simulate manufacturing conditions. The apparatus provides a tubular, multiple component sample holder in which a thin, semi-rigid membrane is suspended. The sample holder includes a set of springs to enable mounting the sample holder firmly in a housing and to allow relatively free vibration of the membrane. A vibrator device is connected to the housing in a location for vibrating the sample holder and the membrane, and controls for vibration magnitude and duration are provided. A quantity of powder or powder blend is placed on the membrane and the vibrator is energized. At the end of the vibration cycle, the sample holder is removed from the housing and the membrane is placed on a base with a split tablet die placed onto the powder with the die cavities facing the powder on the membrane. The assembly is inverted and the split tablet die, with powder filled into the die cavities, is removed and the upper segment of the split tablet die is separated from the bottom segment of the split tablet die, followed by compression of the powder samples in the die cavities, ejection of the tablets and subsequent testing to determine the uniformity of content or particle size in the tablets.

### BRIEF DESCRIPTION OF THE DRAWINGS

The present invention is best understood in conjunction with the accompanying drawing figures in which like elements are identified by similar reference numerals and wherein:

FIG. 1 is a front elevation view of the powder segregation testing apparatus of the present invention.

FIG. 2 is an exploded perspective view of a sample holder for use in the apparatus of FIG. 1.

FIG. 3 is an exploded perspective view of a rig for transferring powder after segregation testing to a split tablet die for tablet compressing.

FIG. 4 is a perspective view of the rig of FIG. 3 in assembled condition.

FIG. 5 is a perspective view of the split tablet die after powder has been inserted into tablet cavities and with a compression ram in position for compressing a cavity of powder into a tablet.

### DETAILED DESCRIPTION OF THE PREFERRED EMBODIMENT

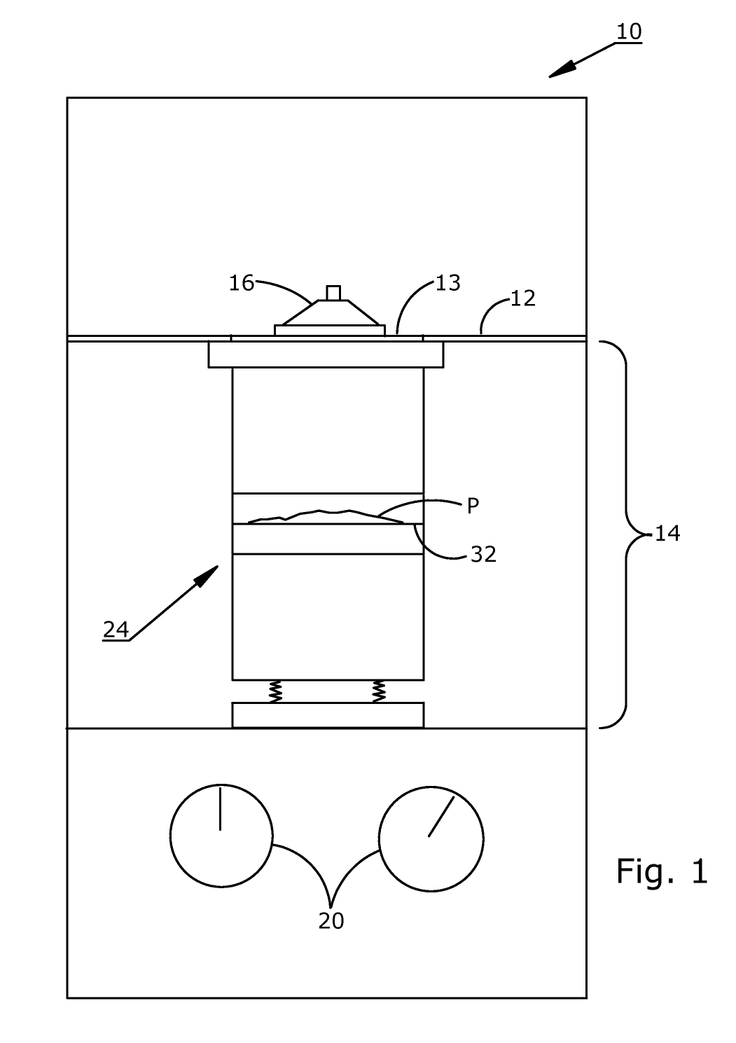

Referring to FIG. 1, a housing 10 of the powder segregation testing apparatus of the present invention is shown in front elevation view. Housing 10 is preferably made of a relatively stiff and relatively dense material capable of transmitting vibrations, for example 316 stainless steel sheet. A shelf 12 extends horizontally across housing 10 in a position to support a vibration device 16. An open chamber 14 is formed in housing 10 below shelf 12 with an assembled sample holder 24 fitted snugly into chamber 14. A quantity of powder or a powder blend P is shown positioned on a membrane 32 within sample holder 24 for segregation testing. A pair of controllers 20 are mounted to housing 10, controllers 20 being provided to control, e.g. the time of testing and the magnitude of vibrations generated by vibrator 16. In a preferred embodiment of the invention, vibrator 16 is a sound generator, or speaker, mounted to shelf 12. In a further preferred embodiment of the invention, shelf 12 has one or more holes 13 through shelf 12 to apply vibrations from vibrator 16 to powder P.

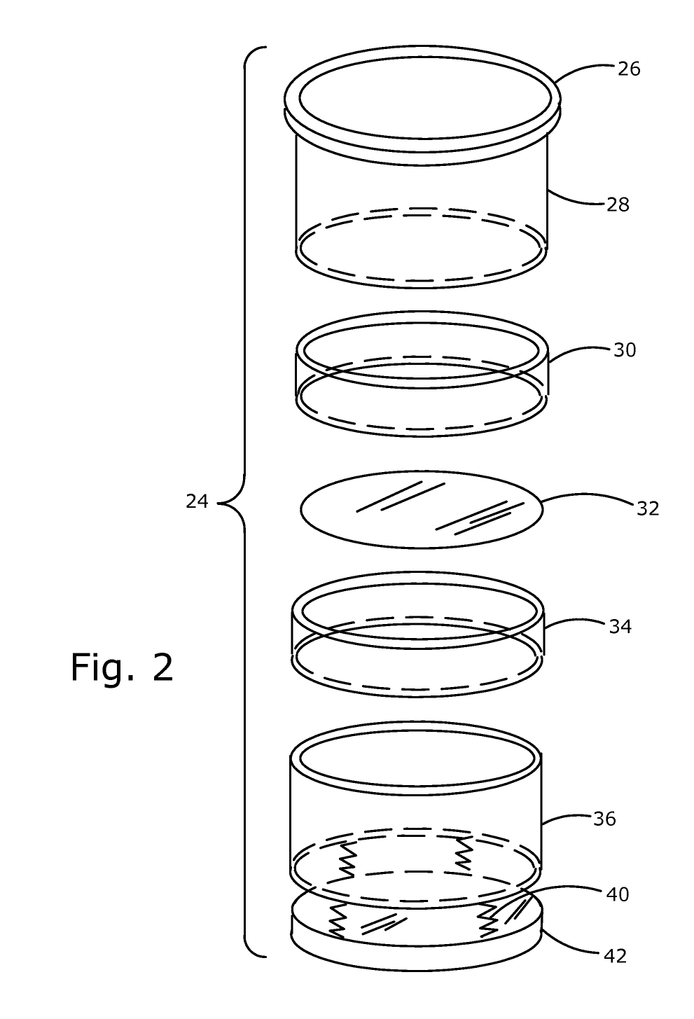

Referring now to FIG. 2, sample holder 24 is illustrated in exploded perspective view. A transmitter ring 26 is formed integrally with, or fixedly mounted to, the top of a cylindrical upper container 28. A top ring 30 is situated below upper container 28. Upper container 28 and top ring 30 are open ended tubular structures that may be circular or of another cross sectional shape. A planar membrane 32 is provided to support a quantity of powder P (see FIG. 1) and configured to engage the lower edge of top ring 30. Membrane 32 is formed of a substantially smooth surfaced, stiff material capable of movement in response to vibration, a preferred material being a 0.076 mm (0.003 inch) thick polyester polymer sheet. An alternate material for membrane 32 is a latex sheet material. The periphery of membrane 32 is supported from below by bottom ring 34, which is supported on lower container 36. Bottom ring 34 and lower container 36 are also open ended tubular structures that may be circular or of another cross sectional shape. Each of upper container 28, top ring 30, bottom ring 34 and lower container 36 are formed with mutually engaging upper and lower edges in order to assemble to one another to form a stable column comprising sample holder 24. An array of resilient members 40, e.g. compression springs, permanently connect lower container 36 to a solid planar base 42. Resilient members 40 permit sample holder 24 to be freely vibrated. For laboratory use, it is preferred to form the components of sample holder 24 of a transparent material, e.g. a plastic resin. While the preferred embodiment of the invention includes upper container 28 and lower container 36, it will be understood that the invention can alternatively function with top ring 30 and bottom ring 34 for holding membrane 32, without the upper and lower containers 30, 36, provided housing 10 is properly sized.

Referring further to FIG. 2, the following is a description of the method steps undertaken to position a quantity of powder or powder blend in sample holder 24. Bottom ring 34 is placed in engagement on lower container 36 and membrane 32 is placed on bottom ring 34. Next, top ring 30 is placed in engagement on bottom ring 34 to securely hold membrane 32. Upper container 28 is then placed in engagement on top ring 30 with transmitter ring 26 at the uppermost position in the assembly.

Continuing with FIG. 2, with sample holder 24 assembled as a column having an open top, and with membrane 32 mounted therein, a measured quantity of powder, or powder blend, is placed on the surface of membrane 32. Sample holder 24 is mounted to housing 10 (see FIG. 1) with resilient members 40 being axially compressed and transmitter ring 26 intimately contacting the lower surface of shelf 12. In this condition, vibrations generated by vibrator 16 (see FIG. 1) cause membrane 32 to move responsively and agitate the powder quantity, instigating possible segregation according to the physical characteristics of the powder particles. The vibratory testing proceeds for a predetermined period of time at which time the testing is stopped and the sample holder is removed from housing 10.

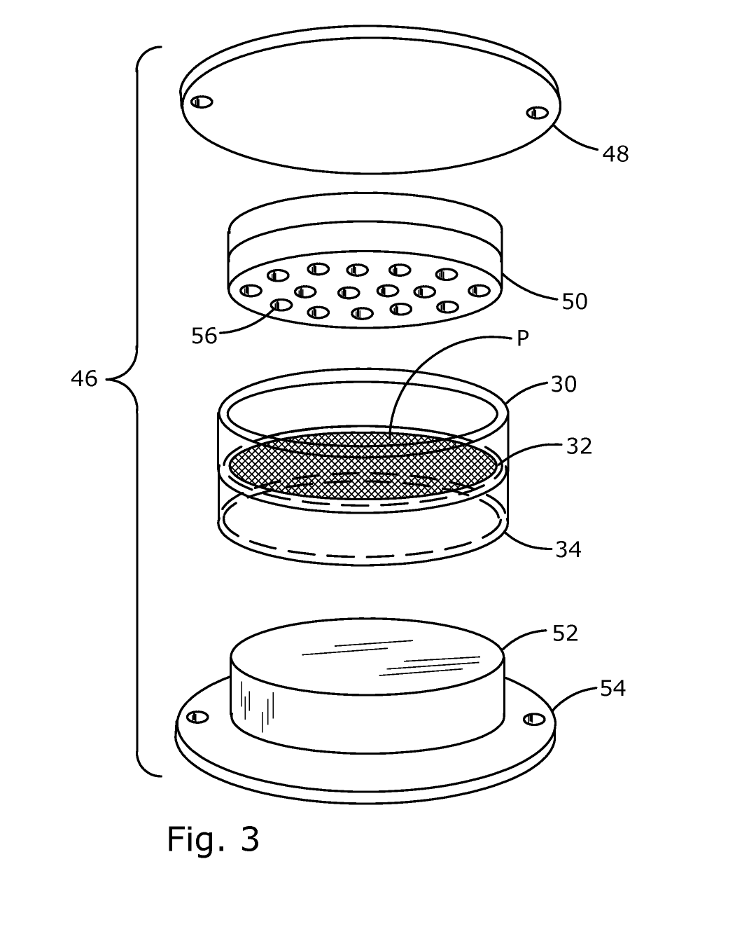

Referring now to FIG. 3, a transfer device 46 is illustrated in exploded perspective view. The central portion of sample holder 24 (see FIG. 2), i.e. top ring 30, membrane 32, and bottom ring 34 are removed as an assembled unit, maintaining the substantially horizontal orientation of membrane 32. A base block 52 is provided, base block 52 formed to slide into bottom ring 34 to support membrane 32, the bottom of base block 52 terminating to be coplanar with the lower lip of bottom ring 34. A bottom plate 54 is provided to support base block 52. Bottom plate 54 is larger in diameter than base block 52 and preferably thinner in cross section. Bottom plate 54 may optionally be fixedly connected to base block 52, according to the intent of the manufacturer.

Referring further to FIG. 3, membrane 32 is resting on base block 52 and bottom ring 34 is resting on bottom plate 54. A split tablet die 50 is formed with a series of cavities 56 in a face plate thereof, cavities 56 are configured to form tablets by compressing powder therein. Split tablet die 50 is placed on powder P and membrane 32 with the cavities 56 of split tablet die 50 oriented downward. The cavity configuration is of any shape appropriate to compress the powder blend being evaluated. Base block 52 serves to support split tablet die 50 to prevent distortion of membrane 32 when the split tablet die is placed thereon. A top plate 48 is then placed on split tablet die 50, top plate 48 being formed to be similar in diameter to bottom plate 54. Bottom plate 54 and top plate 48 may be formed with a plurality of holes to enable screws, or other fasteners, to hold assembled transfer device 46 together.

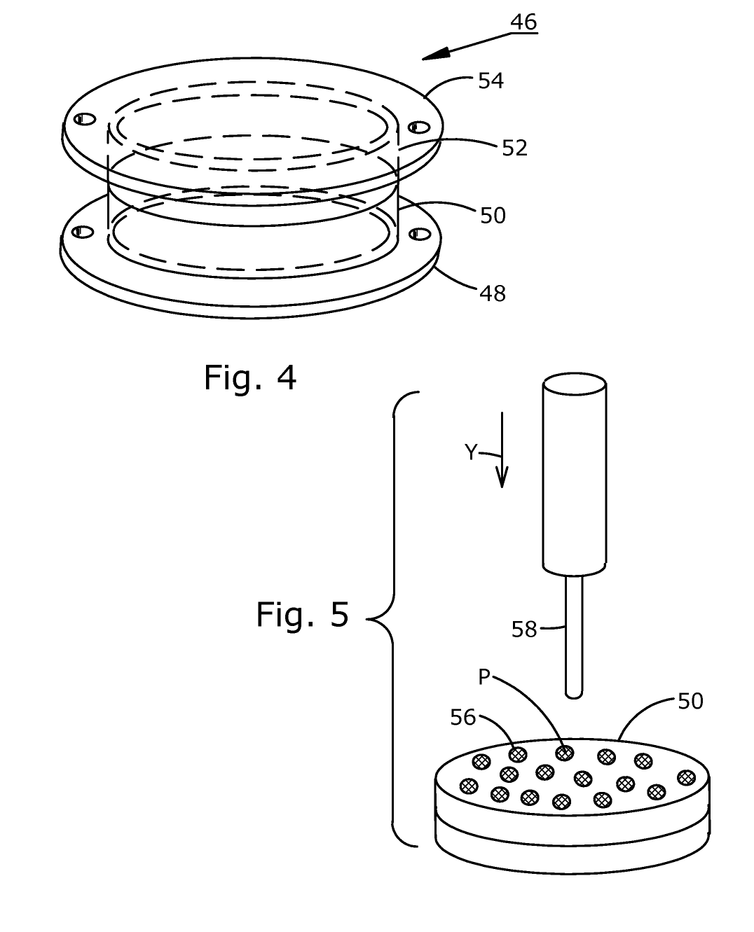

Referring now to FIG. 4, transfer device 46 is shown as fully assembled and inverted. In this condition, bottom plate 54 is seen to be in the uppermost position and top plate 48 in the lowermost position. This inversion results in split tablet die 50 residing below base block 52, therefore orienting split tablet die 50 with cavities 56 (see FIG. 3) facing upward. Maintaining split tablet die 50 with the open ends of the cavities facing upward, bottom plate 54 and base block 52 are then removed to expose the open cavities 56 (see FIG. 3) of split tablet die 50.

Referring now to FIG. 5, split tablet die 50 is illustrated fully separated from the other components shown in FIG. 4. Cavities 56 are facing upward and filled with powder P. It is to be noted that after the full quantity of powder P was placed on membrane 32 (see FIG. 3) and subjected to vibration for a period of time, a degree of segregation of powder P has occurred. Therefore, individual portions of powder P are of different composition. When split tablet die 50 is placed on top of membrane 32 (see FIG. 3) and subsequently inverted, the portions of powder P directly above each cavity 56 will be transferred into the respective cavity 56, substantially avoiding intermixing of the powder samples, this step of the method being critical in order to obtain accurate results. Next, the upper face of split tablet die 50 is scraped or brushed with horizontal motion to remove excess powder P that is not contained within a cavity 56, leaving the quantity of powder in each cavity 56 substantially equal in volume, although not equal in mass.

Referring further to FIG. 5, split tablet die 50 is brought into position beneath a tablet punch 58. Tablet punch 58 is mounted for movement in the direction indicated by arrow Y, either by mechanical or manual drive means. Punch 58 is brought downward to enter each cavity 56 and compress the powder P therein. Split tablet die 50 is moved to bring another cavity 56 beneath punch 58 for compression of the powder P therein. It will be understood that a powder compression device having multiple punches 58 may be used as long as the downward drive force of punch 58 is sufficient to achieve proper compaction of the powder.

When the powder in each of the cavities has been compacted into individual tablets, the upper segment of split tablet die 50 is separated from the bottom segment of split tablet die 50 and the tablets are ejected from the upper segment of the split tablet die 50. Each tablet is then tested for content uniformity of an ingredient, e.g. by U.V. spectrophometry, and the results recorded in terms of relative standard deviation. Another test which can be performed on the non-compressed powder samples is the particle size. Typically, segregation testing will be done on several prototype formulations, and the formulation that yields the lowest relative standard deviation in content or particle size will be regarded as the best formulation in that it is the most likely formulation to withstand the rigors of a manufacturing environment.

While the description above discloses a preferred embodiment of the present invention, it is contemplated that numerous variations and modifications of the invention are possible and are considered to be within the scope of the claims that follow.

What is claimed is:

1. An apparatus for testing powder segregation, comprising:
a. a housing with a vibrator mounted thereto;
b. a sample holder configured for insertion into the housing, whereas when the vibrator is energized, the sample holder is vibrated;
c. a planar membrane removably mounted in substantially horizontal orientation within the sample holder for supporting and vibrating a quantity of powder; and
d. a controller for the vibrator.

2. The apparatus described in claim 1, wherein the sample holder comprises a top ring and a bottom ring for mounting the membrane.

3. The apparatus described in claim 1, further comprising a base block configured for sliding insertion into the bottom ring to contact and support the membrane and a split tablet die configured for sliding insertion into the top ring.

4. The apparatus described in claim 1, further comprising an array of resilient members affixed to the sample holder for permitting free vibration of the sample holder.

5. The apparatus described in claim 1, wherein the sample holder is formed of transparent material.

6. The apparatus described in claim 1, wherein the vibrator comprises a sound generator.

7. An apparatus for testing powder segregation, comprising:
a. a planar membrane supported in substantially horizontal orientation;
b. means connected to the membrane for imparting a vibration to the membrane;
c. means for controlling the vibration for magnitude and duration; and
d. a split tablet die configured for receiving the powder after the powder has been vibrated.

8. The apparatus described in claim 7, wherein the split tablet die is formed with a plurality of cavities.

9. The apparatus described in claim 7, further comprising a top ring and a bottom ring formed for supporting the membrane therebetween.

10. The apparatus described in claim 7, wherein the means for imparting a vibration comprises a sound generator.

11. A method for testing powder segregation, comprising the steps of:
a. supporting a membrane in substantially horizontal orientation;
b. placing a quantity of powder on the membrane;
c. activating a vibrator mounted to be in connection with the membrane;
d. deactivating the vibrator; and
e. analyzing the powder for component uniformity.

12. The method described in claim 11, wherein the step of supporting the membrane comprises the step of placing the membrane between a top ring and a bottom ring.

13. The method described in claim 12, further comprising the step of mounting the top ring and the bottom ring in a housing to which the vibrator is mounted.

14. The method described in claim 11, wherein the step of analyzing the powder for component uniformity comprises the steps of placing the powder into an array of cavities formed in a split tablet die, separating the split tablet die and compressing the powder into tablets.

15. The method described in claim 14, wherein the step of analyzing the powder for component uniformity further comprises the steps of supporting the membrane, placing the split tablet die on the powder with the cavities facing downward and inverting the split tablet die and the membrane to allow the powder to enter the cavities.
